(19) United States
(12) Patent Application Publication
(10) Pub. No.: US 2015/0005991 A1
(43) Pub. Date: Jan. 1, 2015

(54) DETERMINISTIC ETHERNET FOR AN AEROSPACE DISTRIBUTED CONTROL SYSTEM

(71) Applicant: Rolls-Royce Corporation, Indianapolis, IN (US)

(72) Inventors: Adrian C. Willoughby, Zionsville, IN (US); Robert J. Zeller, Noblesville, IN (US)

(73) Assignee: Rolls-Royce Corporation, Indianapolis, IN (US)

(21) Appl. No.: 14/132,568

(22) Filed: Dec. 18, 2013

Related U.S. Application Data
(60) Provisional application No. 61/802,894, filed on Mar. 18, 2013.

(51) Int. Cl. B64C 19/00; B64D 31/00; G06F 1/12

(52) U.S. Cl. CPC B64C 19/00; G06F 1/12; B64D 31/00
USPC 701/3

(57) ABSTRACT

A control system for an aircraft may include a master node and a plurality of slave nodes in communication with each other. The master node and the plurality of slave nodes may each have a processor. The control system may also include at least one data bus connection that enables the communication between the master node and the plurality of slave nodes. The data bus may be governed by any data bus protocol, including, but not limited to, Ethernet. The control system generally may be deterministic in operation.

### CROSS-REFERENCE TO RELATED APPLICATIONS

This application claims priority to U.S. Provisional Patent Application No. 61/802,894 filed Mar. 18, 2013, the contents of which are hereby incorporated in their entirety.

### TECHNICAL FIELD

The present disclosure generally relates to a distributed control system, such as for aerospace and/or military applications, that incorporates deterministic control attributes.

### BACKGROUND

Control systems, such as those used for aerospace or military applications, traditionally have been implemented in a centralized or federated architecture. In a centralized control system, a plurality of nodes, such as those related to speed, pressure, temperature, fuel flow, and the like, are each in direct communication with a central electronic control unit.

In the aerospace and military fields, there has been a move from the centralized architecture to a distributed architecture. In a distributed architecture, the nodes may be connected together by a data bus that may follow any number of data bus protocols. However, such protocols do not consider time critical or deterministic execution, which may be a desirable attribute in aerospace control.

Therefore, there exists a need for a deterministic distributed control system, such as for aerospace and/or military applications.

### BRIEF DESCRIPTION OF THE DRAWINGS

While the claims are not limited to a specific illustration, an appreciation of the various aspects is best gained through a discussion of various examples thereof. Referring now to the drawings, exemplary illustrations are shown in detail. Although the drawings represent the illustrations, the drawings are not necessarily to scale and certain features may be exaggerated to better illustrate and explain an innovative aspect of an example. Further, the exemplary illustrations described herein are not intended to be exhaustive or otherwise limiting or restricted to the precise form and configuration shown in the drawings and disclosed in the following detailed description. Exemplary illustrations are described in detail by referring to the drawings as follows:

FIG. 1 is a schematic block diagram illustrating an exemplary control system having a distributed architecture with deterministic capabilities; and

FIG. 2 is a schematic block diagram of an exemplary aircraft incorporating the control system of FIG. 1.

### DETAILED DESCRIPTION

A distributed control system may be implemented in aerospace and/or military applications. The distributed control system generally may have a master node and a plurality of slave nodes, each of which may include a processor. The master node and the plurality of slave nodes may be connected to a data bus that may enable communication between the nodes.

In such exemplary applications as aerospace and/or military, it may be desirable to have time critical or deterministic execution. To accomplish this, the master node and the slave nodes each may further include a time clock and a software scheduler, where the time clocks may be synchronized and the scheduler may be configured to enable messages to be received within a predetermined time frame. The synchronization and scheduling may be achieved and dictated by a clock synchronization and software scheduling module in each of the master node and the slave nodes.

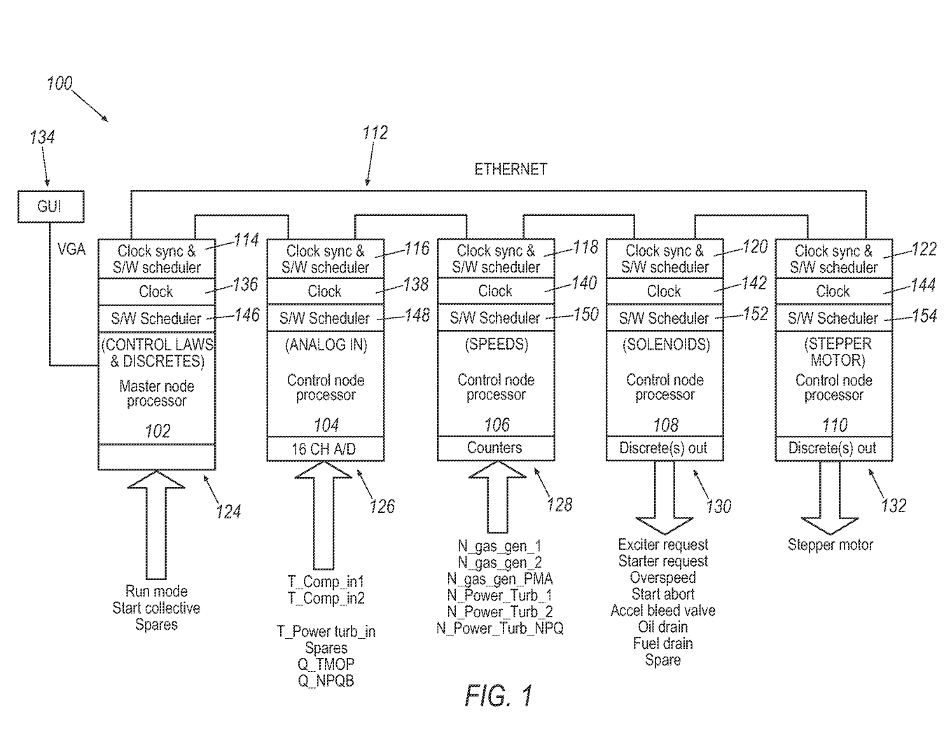

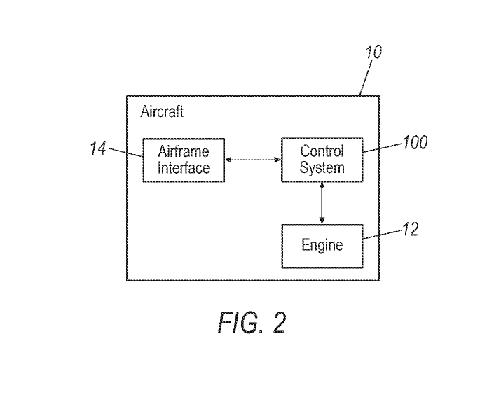

Referring now to the figures, FIG. 1 illustrates an exemplary control system 100. The control system 100 may be implemented in aerospace and/or military applications, such as in an aircraft 10 as illustrated in FIG. 2. The control system 100 generally may be of a distributed architecture that may include a master node 124 and a plurality of slave nodes 126, 128, 130, and 132 in communication with each other. In an exemplary approach, the slave nodes 126, 128, 130, and 132 may be related to control of analog inputs, speeds of an engine 12, as seen in FIG. 2, solenoids (not shown), and a stepper motor (not shown), respectively. While only four slave nodes 126, 128, 130, and 132 are shown, it should be appreciated that there may be any number of slave nodes necessary for any function.

The master node 124 may be configured to receive inputs, such as from an airframe interface 14, as seen in FIG. 2, and to transmit commands and/or requests to the slave nodes 126, 128, 130, and 132. The slave nodes 126, 128, 130, and 132 may also be configured to receive inputs, including, but not limited to, temperatures of different components of the engine, power consumption, and the like, and may also be configured to transmit commands and/or requests, such as to solenoids in the engine, a stepper motor (not shown), and the like. The master node 124 and the slave nodes 126, 128, 130, and 132 may receive and transmit analog and/or digital signals. The master node 124 and the slave nodes 126, 128, 130, and 132 may include processors 102, 104, 106, 108, and 110, described in more detail below.

The communication between the master node 124 and the slave nodes 126, 128, 130, and 132 may be enabled by a data bus 112. The data bus 112 may be any data bus protocol, including, but not limited to, Ethernet. While the data bus 112 is discussed hereinafter as being an Ethernet data bus protocol, it should be appreciated that it may be any data bus protocol. In addition, while the control system 100 is shown in a ring configuration in which the master node 124 and the slave nodes 126, 128, 130, and 132 are connected in series, it should be appreciated that they may be connected in any other configuration, including, but not limited to, a tree-branch configuration in which all of the nodes 124, 126, 128, 130, and 132 are in direct communication with a single data bus.

Generally, on an Ethernet network, a collision may occur as a result of two devices on the same Ethernet network attempting to transmit data at exactly the same time. The Ethernet network detects the “collision” of the two transmitted packets and discards them both, which creates a concern for real time control. To alleviate such concerns, the master node 124 and the slave nodes 126, 128, 128, 130, and 132 further may include clocks 136, 138, 140, 142, and 144, respectively, software schedulers 146, 148, 150, 152, and 154, respectively, and clock synchronization and software scheduling modules 114, 116, 118, 120 and 122, respectively, that may enable the control system 100 to be deterministic in operation.

The clocks 136, 138, 140, 142, and 144 may be synchronized to meet the timing requirements of a distributed system. The synchronization may be achieved by the clock synchronization and software scheduling modules 114, 116, 118, 120, and 122. Timing accuracies may be in the sub-microsecond range. In one exemplary approach, the clock synchronization and software scheduling modules may implement the IEEE 1588 standard to address the clock synchronization requirements of the control system 100.

The software schedulers 146, 148, 150, 152, and 154 may be included to ensure that messages, i.e., inputs and outputs, are received within a certain time frame as required by a deterministic system, which may not be guaranteed despite the clocks 136, 138, 140, 142, and 144 being synchronized. Combining clock synchronization and software scheduling enables the control system 100 to meet the deterministic requirements for aerospace engine control. Any suitable software scheduler may be used, including, but not limited to, Ethernet IP, Profinet, Ethercat, and Ethernet Powerlink.

In one exemplary approach, the clock synchronization and software scheduling modules 114, 116, 118, 120 and 122 may combine software or hardware clock synchronization with the software schedulers 146, 148, 150, 152, and 154 to ensure the Ethernet data bus 112 provides deterministic operation for a real time distributed control system. The protocols used for clock synchronization and/or software scheduling may be open standards.

The control system 100 may further include a graphical user interface (GUI) 134 connected to the master node 124.

Computing devices, such as the processors 102, 104, 106, 108, and 110 and the clock synchronization and software scheduling modules 114, 116, 118, 120 and 122, generally include computer-executable instructions such as the instructions of the master node 102 and the slave nodes 104, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C#, Objective C, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

As described above, the present disclosure may allow different data bus protocols, such as Ethernet, to be used in aerospace applications as the back bone of a deterministic real time control system for aerospace propulsion control systems. Ethernet is an open standard and may be used in future military control systems. IEEE 1588 and many software schedulers are also open standards, allowing for a commercial-off-the-shelf integration that is relatively inexpensive in comparison to current control systems.

The exemplary embodiments described herein may include a number of modules providing a number of functionalities. A module may be implemented as operations by software, hardware, artificial intelligence, fuzzy logic, or any combination thereof, or at least partially performed by a user or operator. In certain embodiments, modules represent software elements as a computer program encoded on a computer readable storage medium, wherein a computer performs the described operations when executing the computer program. A module may be a single device, distributed across devices, and/or a module may be grouped in whole or in part with other modules or devices. The operations of any module may be performed wholly or partially in hardware/software or by other modules. The presented organization of the modules is exemplary only, and other organizations, configurations and arrangements are contemplated.

Operations illustrated are understood to be exemplary only, and operations may be combined or divided, and added or removed, as well as re-ordered in whole or in part, unless explicitly stated to the contrary. The processes disclosed in the present application may be implemented by one or more computing devices executing one or more computer programs stored on a computer readable storage medium. The computer program comprises instructions or operating logic causing the computing device to execute one or more operations. In certain embodiments, the computer program may be comprised of modules, such as those described herein.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by any claims that follow.

1. A control system for an aircraft comprising:
a master node and a plurality of slave nodes in communication with each other, the master node and the plurality of slave nodes each having a processor; and
at least one data bus connection that enables the communication between the master node and the plurality of slave nodes;
wherein the control system is deterministic.

2. The control system of claim 1 wherein the data bus is governed by an Ethernet data bus protocol.

3. The control system of claim 1 further comprising a graphic user interface (GUI) in communication with the master node.

4. The control system of claim 1 wherein the master processor and the at least one control processor are in direct

5. The control system of claim 1 wherein the master processor node is mounted on the aircraft.

6. The control system of claim 1 wherein the master node and the plurality of slave nodes each further comprises a clock and a software scheduler, the clocks being synchronized and the software schedulers being configured to enable signals to be transmitted and received within a predetermined time frame.

7. The control system of claim 6 wherein the master node and the plurality of slave nodes each further comprise a clock synchronization and software scheduling modules configured to enable the clock synchronization and the software scheduling.

8. The control system of claim 1 wherein the master node and the plurality of slave nodes are connected by the at least one data bus in a ring configuration.

9. An aircraft comprising:
an engine;
a control system in communication with the engine, the control system having:
a master node and a plurality of slave nodes in communication with each other, the master node and the plurality of slave nodes each having a processor, the slave nodes being configured to receive and transmit signals from at least the master node and the engine; and
at least one data bus connection that enables the communication between the master node and the plurality of slave nodes;
an airframe interface in communication with the control system, the airframe being configured to transmit commands to the control system;
wherein the master node and the plurality of slave nodes are coordinated such that the control system is deterministic in operation.

10. The aircraft of claim 9 wherein the data bus is governed by an Ethernet data bus protocol.

11. The aircraft of claim 9 further comprising a graphic user interface (GUI) in communication with the master node.

12. The aircraft of claim 9 wherein the master processor and the at least one control processor are in direct

13. The aircraft of claim 9 wherein the master processor node is mounted on the aircraft.

14. The aircraft of claim 9 wherein the master node and the plurality of slave nodes each further comprises a clock and a software scheduler, the clocks being synchronized and the software schedulers being configured to enable signals to be transmitted and received within a predetermined time frame.

15. The aircraft of claim 14 wherein the master node and the plurality of slave nodes each further comprises a clock synchronization and software scheduling module configured to enable the clock synchronization and the software scheduling.

16. The aircraft of claim 9 wherein the master node is mounted on the engine.

17. The aircraft of claim 9 wherein the master node and the plurality of slave nodes are connected by the at least one data bus in a ring configuration.
